(19) United States
(12) Patent Application Publication
(10) Pub. No.: US 2006/0291253 A1
(43) Pub. Date: Dec. 28, 2006

(54) Light-guide plate, backlight assembly and liquid crystal display device having the same

(76) Inventors: Heu-Gon Kim, Suwon-si (KR); In-Sun Hwang, Suwon-si (KR); Jheen-Hyeok Park, Seongnam-si (KR); Tae-Seok Jang, Seoul (KR); Seung-Chul Jeong, Seongnam-si (KR); Tae-Gil Kang, Suwon-si (KR); Jin-Sung Choi, Cheonan-si (KR)

Correspondence Address: F. CHAU & ASSOCIATES, LLC, 130 WOODBURY ROAD, WOODBURY, NY, 11797, US

(21) Appl. No.: 11/449,353

(22) Filed: Jun. 8, 2006

(30) Foreign Application Priority Data
Jun. 10, 2005 (KR) 2005-49910
Sep. 5, 2005 (KR) 2005-82045

(51) Int. Cl. F21V 7/04

(52) U.S. Cl. 362/620; 362/626

(57) ABSTRACT

A light-guide plate (LGP) includes a light-incident surface, a light-facing surface, a light-emitting surface and a light-reflecting surface. The light-incident surface receives light. The light-facing surface has a smaller size than that of the light-incident surface. The light-facing surface faces the light-incident surface. The light-emitting surface is extended substantially perpendicular to the upper side of the light-incident surface. The light-emitting surface is connected to the upper edge of the light-facing surface. The light-reflecting surface has a plurality of first prism patterns that are formed parallel with the light-incident surface. The light-reflecting surface is extended from the base of the light-incident surface to be connected to the base of the light-facing surface. Therefore, a leakage of light that exits from the wedge-type LGP through a side surface of the wedge-type LGP is decreased, so that luminance is enhanced.

### CROSS-REFERENCE TO RELATED FOREIGN APPLICATIONS

This application relies for priority upon Korean Patent Application No. 2005-49910 filed on Jun. 10, 2005 and Korean Patent Application No. 2005-82045 filed on Sep. 5, 2005, the contents of which are herein incorporated by reference in their entireties.

### BACKGROUND OF THE INVENTION

1. Field of the Invention

The present invention relates to a light-guide plate, a backlight assembly having the light-guide plate, and a liquid crystal display device having the backlight assembly. More particularly, the present invention relates to a light-guide plate capable of enhancing total luminance characteristics, a backlight assembly having the light-guide plate, and a liquid crystal display device having the backlight assembly.

2. Description of the Related Art

In general, a liquid crystal display (LCD) device displays an image using liquid crystal that has optical characteristics such as refractive index anisotropy and electrical characteristics such as dielectric constant anisotropy. The LCD device has various characteristics such as thinner thickness, lower driving voltage, lower power consumption, etc., than other display devices such as cathode ray tube (CRT) devices, plasma display panel (PDP) devices, etc. Therefore, the LCD device has been widely used in various industrial fields.

The LCD device includes an LCD panel that has a thin-film transistor (TFT) substrate, a color filter substrate facing the TFT substrate and a liquid crystal layer, which changes light transmittance, disposed between the TFT substrate and the color filter substrate.

Moreover, the LCD device is a non-emissive type display device, so that the LCD device necessarily requires a light source such as a backlight assembly to supply the LCD panel of the LCD device with light.

A conventional backlight assembly includes a lamp that generates light and a light-guide plate (LGP) that guides a path of the light that is generated from the lamp to be incident into the LCD panel.

The LGP is classified into a flat-type LGP and a wedge-type LGP. The flat-type LGP has a light-incident surface and a light-facing surface, which is the same size as the light-incident surface, facing the light-incident surface. In contrast, the wedge-type LGP has a light-incident surface and a light-facing surface, which is different in size from the light-incident surface, facing the light-incident surface. Particularly, the size of the light-incident surface is larger than the size of the light-facing surface. That is, a thickness of the wedge-type LGP is decreased, as a distance from the light-incident surface is increased.

Recently, in order to prevent discoloration of the LGP and to enhance luminance of the LGP, a prism LGP having a prism pattern, instead of a printed pattern that is printed in the lower portion of the LGP has been proposed.

In the flat-type LGP, the light that is incident into the LGP satisfies a total reflection condition, and thus the light only exits the LGP through the prism pattern.

However, in the wedge-type LGP, the light does not exit the LGP through only the prism pattern. In addition, a portion of light that does not satisfy a total reflection condition and leaks from the LGP through a side surface of the LGP is gradually increased, as a distance from the light-facing surface is decreased. Therefore, luminance of the wedge-type LGP is decreased.

### SUMMARY OF THE INVENTION

Exemplary embodiments of the present invention provide a light-guide plate (LGP) capable of enhancing total luminance characteristics by decreasing a leakage of light that exits the LGP through a side surface of the LGP, and enhancing uniformity of the luminance characteristics and transferability of an injection molding.

Embodiments of the present invention also provide a backlight assembly having the above-mentioned LGP and a liquid crystal display (LCD) device having the above-mentioned backlight assembly.

In one aspect of the present invention, the LGP includes a light-incident surface, a light-facing surface, a light-emitting surface and a light-reflecting surface. The light-incident surface receives light. The light-facing surface has a smaller size than that of the light-incident surface. The light-facing surface faces the light-incident surface. The light-emitting surface is extended substantially perpendicular to the upper side of the light-incident surface. The light-emitting surface is connected to the upper edge of the light-facing surface. The light-reflecting surface has a plurality of first prism patterns that are formed substantially parallel with the light-incident surface. The light-reflecting surface is extended from the base of the light-incident surface to be connected to the base of the light-facing surface.

In another aspect of the present invention, the LGP includes a light-incident surface, a light-facing surface, a light-emitting surface and a light-reflecting surface. The light-incident surface receives light. The light-facing surface has a smaller size than that of the light-incident surface. The light-facing surface faces the light-incident surface. The light-emitting surface has a plurality of second prism patterns that are extended substantially perpendicular to the light-incident surface. The light-emitting surface is extended substantially perpendicular to the upper side of the light-incident surface, and is connected to the upper edge of the light-facing surface. The light-reflecting surface has a plurality of first prism patterns that are formed substantially parallel with the light-incident surface. The light-reflecting surface is extended from the base of the light-incident surface to be connected to the base of the light-facing surface.

In another aspect of the present invention, the backlight assembly includes a lamp, a light-guide plate (LGP) and a reflective sheet. The lamp generates light. The light-guide plate guides a path of the light generated from the lamp. The reflective sheet is disposed below the LGP. The LGP includes a light-incident surface, a light-facing surface, a light-emitting surface and a light-reflecting surface. The light-incident surface receives the light. The light-facing surface has a smaller size than that of the light-incident surface. The light-facing surface faces the light-incident surface. The light-emitting surface is extended substantially perpendicular to the upper side of the light-incident surface. The light-emitting surface is connected to the upper edge of the light-facing surface. The light-reflecting surface has a plurality of first prism patterns that are formed substantially parallel with the light-incident surface. The light-reflecting surface is extended from the base of the light-incident surface to be connected to the base of the light-facing surface.

In another aspect of the present invention, the LCD device includes a backlight assembly and a display assembly. The backlight assembly has a lamp generating light and an LGP guiding a path of the light generated from the lamp. The display assembly has a liquid crystal layer. The display assembly displays an image using the light having passed through the liquid crystal layer. The LGP includes a light-incident surface, a light-facing surface, a light-emitting surface and a light-reflecting surface. The light-incident surface receives light. The light-facing surface has a smaller size than that of the light-incident surface. The light-facing surface faces the light-incident surface. The light-emitting surface is extended substantially perpendicular to the upper side of the light-incident surface. The light-emitting surface is connected to the upper edge of the light-facing surface. The light-reflecting surface has a plurality of first prism patterns that are formed substantially parallel with the light-incident surface. The light-reflecting surface is extended from the base of the light-incident surface to be connected to the base of the light-facing surface.

According to the LGP, the backlight assembly having the LGP and an LCD device having the backlight assembly, leakage of light that exits the wedge-type LGP through a side surface of the wedge-type LGP is decreased, so that luminance is enhanced. Furthermore, uniformity of the luminance and transferability of an injection molding are enhanced.

### BRIEF DESCRIPTION OF THE DRAWINGS

Embodiments of the present invention will be described in detail below with reference to the following accompanying drawings.

FIG. 1 is an exploded perspective view illustrating a backlight assembly according to one exemplary embodiment of the present invention;

FIG. 2 is an enlarged cross-sectional view taken along the line I-I′ in FIG. 1;

FIG. 3 is a plan view illustrating a light-reflecting surface of the light-guide plate (LGP) in FIG. 1;

FIG. 4 is an enlarged cross-sectional view illustrating portion ‘A’ in FIG. 2;

FIG. 5 is an enlarged cross-sectional view illustrating portion ‘B’ in FIG. 4;

FIG. 6 is an enlarged cross-sectional view illustrating first prism patterns as shown in FIG. 5, according to another exemplary embodiment of the present invention;

FIG. 7 is a graph showing a relationship between a vertical light-emitting angle and luminance according to a ratio of a base length of a first slanted surface to a base length of a second slanted surface in FIG. 6;

FIG. 8 is a graph showing a relationship between a vertical light-emitting angle and luminance according to a ratio of a base length of a first slanted surface to a base length of a second slanted surface;

FIG. 9 is an enlarged cross-sectional view illustrating first prism patterns as shown in FIG. 5, according to another exemplary embodiment of the present invention;

FIG. 10 is a graph showing a relationship between a vertical light-emitting angle and luminance according to a ratio of a base length of a first slanted surface to a base length of a second slanted surface;

FIG. 11 is an enlarged cross-sectional view illustrating first prism patterns according to another exemplary embodiment as shown in FIG. 5;

FIG. 12 is a plan view illustrating first prism patterns according to another exemplary embodiment as shown in FIG. 3;

FIG. 13 is a plan view illustrating first prism patterns according to another exemplary embodiment as shown in FIG. 3;

FIG. 14 is a perspective view illustrating an LGP according to another exemplary embodiment of the present invention;

FIG. 15 is an enlarged perspective view illustrating portion ‘C’ in FIG. 14; and

FIG. 16 is an exploded perspective view illustrating a liquid crystal display (LCD) device according to an exemplary embodiment of the present invention.

### DETAILED DESCRIPTION OF THE EXEMPLARY EMBODIMENTS

Exemplary embodiments of the invention are described more fully hereinafter with reference to the accompanying drawings, in which exemplary embodiments of the invention are shown. This invention may, however, be embodied in many different forms and should not be construed as limited to the embodiments set forth herein.

Hereinafter, exemplary embodiments of the present invention will be explained in detail with reference to the accompanying drawings.

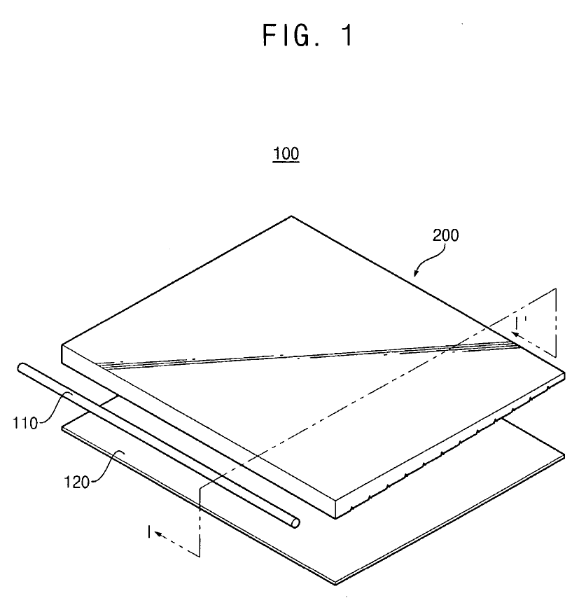

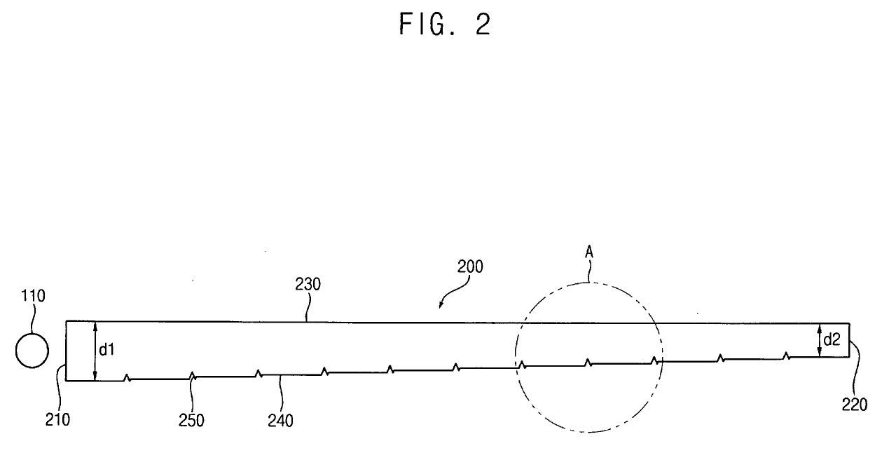

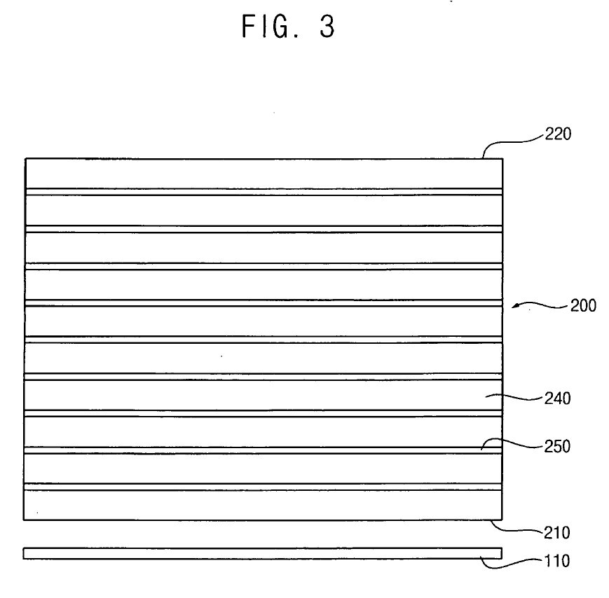

FIG. 1 is an exploded perspective view illustrating a backlight assembly according to an example embodiment of the present invention. FIG. 2 is an enlarged cross-sectional view taken along the line I-I′ in FIG. 1. FIG. 3 is a plan view illustrating a light-reflecting surface of the light-guide plate (LGP) in FIG. 1.

Referring to FIGS. 1 to 3, a backlight assembly according to an exemplary embodiment of the present invention includes a lamp 110, an LGP 200 and a reflective sheet 120. The lamp 110 generates light. The LGP 200 guides a path of the light that is generated from the lamp 110. The reflective sheet 120 is disposed below the LGP 200.

The lamp 110 is disposed in a first end portion of the LGP 200. The lamp 110 generates the light in response to power that is provided from an external device (not shown). The lamp 110 can include, for example, a hollow and cylindrical-shaped cold cathode fluorescent lamp (CCFL). Alternatively, the lamp 110 can include an external electrode fluorescent lamp (EEFL) having two electrodes formed in two outer surfaces of an end portion of the EEFL.

The backlight assembly 100 may further include a lamp cover (not shown) to protect the lamp 110. The lamp cover 100 may cover three adjacent. sides of the lamp 110 to protect the lamp 110. The lamp cover 100 reflects the light generated from the lamp 110 toward the LGP 200 to enhance light-using efficiency.

The LGP 200 guides a path of the light that is generated from the lamp 110. The LGP 200 includes an optically transparent material to guide the light. For example, the LGP 200 can include polymethyl methacrylate (PMMA).

The LGP 200 includes a light-incident surface 210, a light-facing surface 220, a light-emitting surface 230 and a light-reflecting surface 240. The light generated from the lamp 110 is incident into the LGP 200 through the light-incident surface 210 of the LGP 200. The light-facing surface 220 has a smaller size than that of the light-incident surface 210. The light-emitting surface 230 is extended substantially perpendicular to the upper side of the light-incident surface 210, and is connected to the upper edge of the light-facing surface 220. The light-reflecting surface 240 is extended from the base of the light-incident surface 210, and is connected to the base of the light-facing surface 220. Therefore, the LGP 200 has a wedge shape with a thickness of the LGP 200 at the light-facing surface 220 being less than a thickness of the LGP 200 at the light-incident surface 210. That is, the thickness of the LGP 200 is decreased, as a distance from the light-incident surface 210 is increased.

A plurality of first prism patterns 250 is formed in the light-reflecting surface 240 of the LGP 200. The first prism patterns 250 have a stripe shape substantially parallel with the light-incident surface 210 as shown in FIG. 3. That is, the first prism patterns 250 are formed substantially parallel with a longitudinal direction of the lamp 110. Moreover, the first prism patterns 250 are spaced apart from each other at constant intervals.

The light-reflecting surface 240 that is disposed between the first prism patterns 250 is formed substantially parallel with the light-emitting surface 230 so that the light incident into the LGP 200 is totally reflected from the light-reflecting surface 240. That is, the light-reflecting surface 240 that is disposed between the first prism patterns 250 is formed substantially perpendicular to the light-incident surface 210.

Therefore, the light that is incident into the LGP 200 through the light-incident surface 210 is totally reflected from the light-reflecting surface 240 and the light-emitting surface 230. Then, a reflecting angle of the totally reflected light is changed by the first prism patterns 250, and the totally reflected light exits the LGP 220 in a vertical direction through the light-emitting surface 230.

For example, the first prism patterns 250 can be formed on the light-reflecting surface 240 through an injection molding process. Alternatively, the prism patterns 250 can be formed in the light-reflecting surface 240 through various processing methods such as a stamping method.

The reflective sheet 120 is disposed at the light-reflecting surface 240 of the LGP 200 to reflect the light that has leaked from the LGP 200 through the light-reflecting surface 240 of the LGP 200 toward the LGP 200. The reflective sheet 120 includes a material having a high reflectivity. Examples of the highly reflective material that can be used for the reflective sheet 120 include white polyethylene terephthalate (PET), white polycarbonate (PC), etc. Alternatively, the reflective sheet 120 may include a metal plate such as aluminum (Al), which is formed on a white reflective sheet.

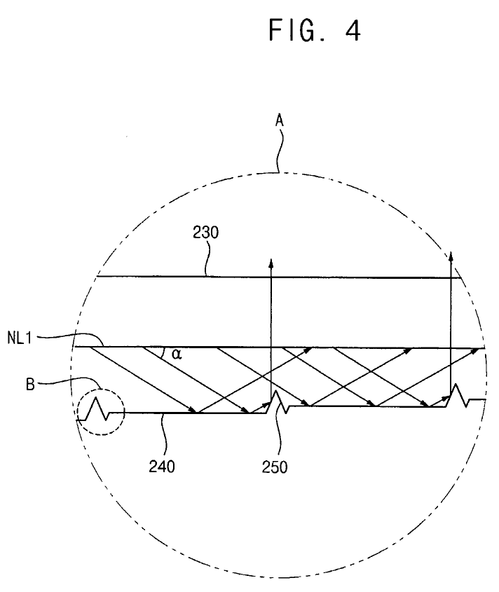

FIG. 4 is an enlarged cross-sectional view illustrating portion ‘A’ in FIG. 2.

Referring to FIGS. 2 and 4, first prism patterns 250 are formed in the light-reflecting surface 240 of the LGP 200. The first prism patterns 250 are formed at uniform intervals. The light-reflecting surface 240 that is disposed between the first prism patterns 250 is formed substantially parallel with the light-emitting surface 230.

The light that is incident into the LGP 200 through the light-incident surface 210 of the LGP 200 is incident into the LGP 200 at an angle no more than a critical reflection angle ‘α’, based on a first normal line NL1 of the light-incident surface 210. The critical reflection angle ‘α’ is the lowest angle enabling the total reflection.

The critical reflection angle ‘α’ may be obtained by the following Equation 1 that shows Snell's law.
n1/n2=sin θ2/sin θ1 Equation 1

In Equation 1, n1 and n2 represent a first refractive index of the first medium and a second refractive index of a second medium, respectively. Moreover, θ1 represents a first angle between a normal line of an incident surface and an incident light in the first medium, and θ2 represents a second angle between the normal line of the incident surface and an incident light in the second medium.

When a density of the second medium is higher than a density of the first medium, the second refractive index n2 of the second medium is greater than the first refractive index n1 of the first medium. Therefore, in order to satisfy Equation 1, the second angle θ2 between a normal line of an incident surface and an incident light in the first medium is smaller than the first angle θ1 between the normal line of the incident surface and an incident light in the second medium.

When the light exits the first medium having a high density, and is incident into the second medium having a low density, the first and second angles θ1 and θ2 are increased. In addition, when the first angle θ1 is about 90°, the second angle θ2 corresponds to the critical reflection angle α.

In Equation 1, the critical reflection angle α is expressed as following Equation 2.
α=sin⁻¹(n1/n2) Equation 2

Accordingly, the critical reflection angle α is determined by the first refractive index n1 of the first medium and the second refractive index n2 of the second medium.

In FIGS. 1 to 4, the first medium is an air layer interposed between the lamp 110 and the LGP 200, and the second medium is the LGP 200. A refractive index of the air layer is about one. When the LGP 200 includes, for example, polymethyl methacrylate (PMMA), the refractive index of the LGP 200 is about 1.49. Therefore, the critical reflection angle ‘α’ is about 42.160 in the PMMA-type LGP.

The light that is irradiated onto the light-incident surface 210 of the LGP 200 is incident into the LGP 200 at the angle of no more than a critical reflection angle ‘α’. The light that is incident into the LGP 200 is irradiated onto the light-reflecting surface 240 or the light-emitting surface 230. Hence, a portion of the light incident into the LGP and satisfying a total reflection condition of the LGP 200 is reflected from the light-reflecting surface 240 or the light-emitting surface 230 to be reflected again into the LGP 200. However, the remaining portion of the light that does not satisfy the total reflection condition exits the LGP 200.

That is, the portion of the light that is irradiated onto the light-emitting surface 230 at an angle of no more than the critical angle ‘α’, based on the normal line NL of the light-emitting surface 230, is reflected from the light-reflecting surface 240 or the light-emitting surface 230 to repeat the reflection in the LGP 200. However, the light that is irradiated onto the light-emitting surface 230 at an angle of greater than the critical angle ‘α’ exits the LGP 200.

The light-reflecting surface 240 that is disposed between the first prism patterns 250 is formed substantially parallel with the light-emitting surface 230, so that the light that is irradiated onto the light-reflecting surface 240 having a smaller angle than the critical angle ‘α’, based on the normal line NL of the light-emitting surface 230, is totally reflected. However, an incident angle of a portion of the light irradiated onto the light-reflecting surface 240 is changed by the first prism patterns 250, so that the light irradiated onto the light-emitting surface 230 at a smaller angle than the critical angle ‘α’, based on the normal line NL of the light-emitting surface 230, exits the LGP 200.

Therefore, the light that is incident into the LGP 220 through the light-incident surface 210 is totally reflected from the light-reflecting surface 240 that is disposed between the light-emitting surface 230 and the first prism patterns 250. Then, a reflecting angle of the totally reflected light is changed by the first prism patterns 250, so that the totally reflected light having the changed reflecting angle exits the LGP 220 through the light-emitting surface 230.

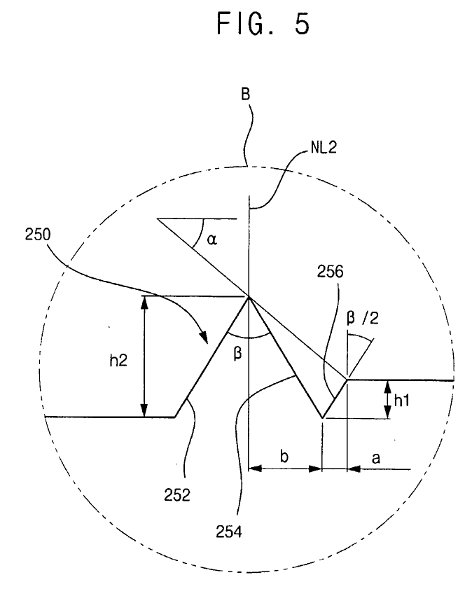

FIG. 5 is an enlarged cross-sectional view illustrating a portion ‘B’ in FIG. 4.

Referring to FIGS. 2 and 5, the first prism patterns 250 that are formed in the light-reflecting surface 240 of the LGP 200 includes a plurality of grooves having a substantially triangular shape so that the light that is incident into the LGP 200 exits the LGP 200 in a vertical direction.

The first prism patterns 250 include a first slanted surface 252, a second slanted surface 254 that is connected to the first slanted surface 252, and a third slanted surface 256 that is connected to the second slanted surface 254.

The first slanted surface 252 is extended from the light-reflecting surface 240 toward the light-emitting surface 250, and is inclined with respect to the light-reflecting surface 240. The second slanted surface 254 is extended from the first slanted surface 252 toward the light-reflecting surface 240, and is inclined with respect to the first slanted surface 252. The third slanted surface 256 is extended from the second slanted surface 254, and is substantially parallel with the first slanted surface 252. The third slanted surface 256 is connected to the light-reflecting surface 240.

The first and second slanted surfaces 252 and 254 are substantially symmetric based on a second normal line NL2 of the light-emitting surface 230.

The LGP 200 has a first thickness d1 at the light-incident surface 210, and has a second thickness d2 at the light-facing surface 220 that is thinner than the first thickness d1. The light-reflecting surface 240 that is disposed between the first prism patterns 250 is substantially parallel with the light-emitting surface 230. Therefore, a previous portion of each of the first prism patterns 250 has a different thickness from a following portion of each of the first prism patterns 250.

A first height h1 of the third slanted surface 256 which is substantially the same as the thickness difference between the thickness of the previous portion of each of the first prism patterns 250 and the thickness of the following portion of the first prism patterns 250, may be obtained by the following Equation 3.
h1=(d1−d2)/m Equation 3

In Equation 3, d1 and d2 represent a first thickness of the LGP 200 at the light-incident surface 210 and a second thickness of the LGP 200 at the light-facing surface 220, respectively. Moreover, m represents a number of steps of the light-reflecting surface 240.

That is, a first height h1 of the third slanted surface 256 is obtained by the thickness difference of the LGP 200 at the light-incident surface 210 and at the light-facing surface 220 and the number of steps of the light-reflecting surface 240.

Alternatively, the second height h2 of the first slanted surface 252, the first base length ‘a’ of the third slanted surface 256, the second base length ‘b’ of the second slanted surface 254, etc., are adjusted within so that the leakage of light through the side surface of the LGP 200 is minimized.

The second height h2 of the first slanted surface 252 may be adjusted so that a height having an angle of no more than the critical reflection angle ‘α’ with respect to the normal line NL of the light-incident surface 210, is not irradiated onto the third slanted surface 256. Therefore, the second height ‘h2’ of the first slanted surface 252 may be obtained by the following Equation 4.
h1=h1×[1+tan(α)tan(β/2)]/[1−tan(α)tan(β/2)] Equation 4

In Equation 4, α and β represent a critical angle and an interior angle between the first slanted surface 252 and a second slanted surface 254, respectively.

Moreover, a base length ‘a’ of the third slanted surface 256 may be obtained by the following Equation 5.
a=h1×tan(β/2) Equation 5

Moreover, a base length ‘b’ of the second slanted surface 254 may be obtained by the following Equation 6.
b=h2×tan(β/2) Equation 6

Moreover, an interior angle ‘β’ between the first slanted surface 252 and the second slanted surface 254 is about 60° to about 90° so that the light incident into the LGP 200 is guided in the vertical direction. For example, the interior angle ‘β’ between the first slanted surface 252 and the second slanted surface 254 may be about 78°.

When the LGP 200 includes PMMA, the interior angle ‘β’ is about 42.16°. For example, when a length between the light-incident surface 210 of the PMMA LGP and the light-facing surface 220 is about 213 mm, and a pitch between the first prism patterns 250 is about 300 μm, and the number of steps of the light-reflecting surface 240 is about 710.

When the first thickness d1 of the LGP 200 at the light-incident surface 210 of the PMMA LGP is about 2.6 mm, and the second thickness d2 of the LGP 200 at the light-facing surface 220 is about 0.7 mm, a thickness difference between the first and second thicknesses d1 and d2 is about 1.9 mm. Therefore, the first height h1 of the third slanted surface 256 is about 2.68 μm according to Equation 3.

When the interior angle ‘β’ between the first slanted surface 252 and the second slanted surface 254 is about 78°, the second height h2 of the first slanted surface 252 is about 17.38 μm based on Equation 4, the base length ‘a’ of the third slanted surface 256 is about 2.17 μm based on Equation 5, and the base length ‘b’ of the second slanted surface 254 is about 14.07 μm based on Equation 6.

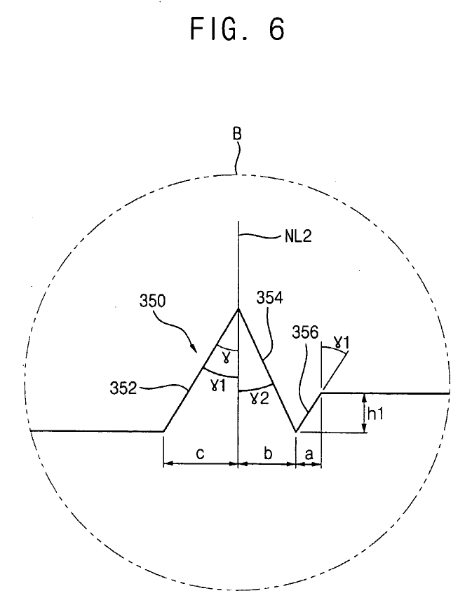

FIG. 6 is an enlarged cross-sectional view illustrating first prism patterns as shown in FIG. 5, according to another exemplary embodiment of the present invention.

Referring to FIGS. 2 and 6, the first prism patterns 350 include a first slanted surface 352, a second slanted surface 354 that is connected to the first slanted surface 352, and a third slanted surface 356 that is connected to the second slanted surface 354.

The first slanted surface 352 is inclined with respect to the light-reflecting surface 240 toward the light-emitting surface 230. The second slanted surface 354 is inclined with respect to the first slanted surface 352 toward the light-reflecting surface 240. The third slanted surface 356 is extended from the second slanted surface 354 substantially parallel with the first slanted surface 352, and is connected to the light-reflecting surface 240.

The first slanted surface 352 and the second slanted surface 354 are substantially asymmetric with respect to a second normal line NL2 of the light-emitting surface 230. That is, an angle γ between the first and second slanted surfaces 352 and 354 is divided into a first angle γ1 corresponding to a base length ‘c’ of the first slanted surface 352, and a second angle γ2 corresponding to a base length ‘b’ of the second slanted surface 354. The first angle γ1 is different from the second angle γ2. In particular, the base length ‘c’ of the first slanted surface 352 is greater than the base length ‘b’ of the second slanted surface 354. In order to enhance luminance, the ratio of the base length ‘c’ to the base length ‘b’ is about 4:3.

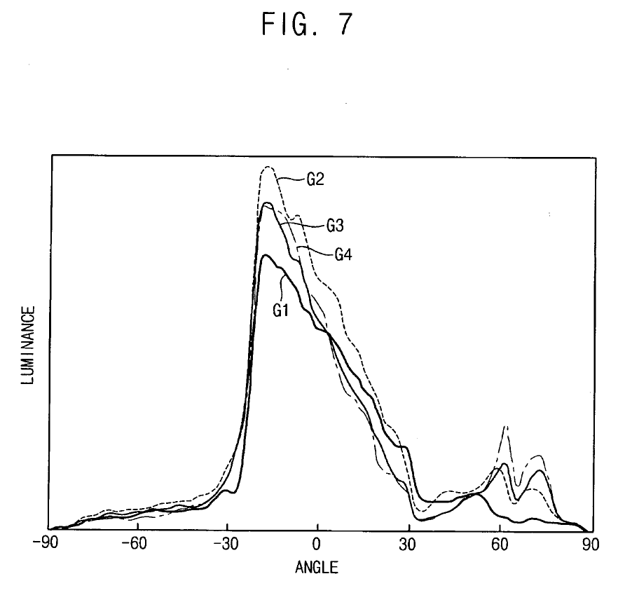

FIG. 7 is a graph showing a relationship between a vertical light-emitting angle and luminance in accordance with a ratio of a base length of a first slanted surface to a base length of a second slanted surface in FIG. 6. In FIG. 7, a graph line G1 that represents the ratio of the base length ‘c’ to the base length ‘b’ is about 1:1, a graph line G2 that represents the ratio of the base length ‘c’ to the base length ‘b’ is about 4:3, a graph line G3 that represents the ratio of the base length ‘c’ to the base length ‘b’ is about 2:1, and a graph line G4 that represents the ratio of the base length ‘c’ to the base length ‘b’ is about 4:1.

Referring to FIGS. 6 and 7, when the ratio of the base length ‘c’ of the first slanted surface 352 to the base length ‘b’ of the second slanted surface 354 is about 4:3, the luminance of the vertical light-emitting angle is the highest. Therefore, in FIG. 6, the ratio of the base length ‘c’ of the first slanted surface 352 to the base length ‘b’ of the second slanted surface 354 is about 4:3, so that the luminance of the light that exits the LGP 200 through the light-emitting surface 230 of the LGP 200 is maximized.

Moreover, the light-emitting angle of the light that exits the LGP 200 through the light-emitting surface 230 of the LGP 200 is changed by the interior angle between the first slanted surface 352 and the second slanted surface 354. Hence, a length of the base length ‘c’ of the first slanted surface 352 is different from a length of the base length ‘b’ of the second slanted surface 354, so that a first interior angle γ1 and a second interior angle γ2 are different from each other. The first interior angle γ1 is an angle between the first slanted surface 352 and a second normal line NL2 of the light-emitting surface 230. The second interior angle γ2 is an angle between the second slanted surface 354 and the second normal line NL2.

In order to enhance the distribution of the vertical light-emitting angle, the first interior angle γ1 between the first slanted surface 352 and the second normal line NL2 of the light-emitting surface 230 may be about 34° to about 44°. For example, the first interior angle γ1 between the first slanted surface 352 and the second normal line NL2 of the light-emitting surface 230 may be about 39°.

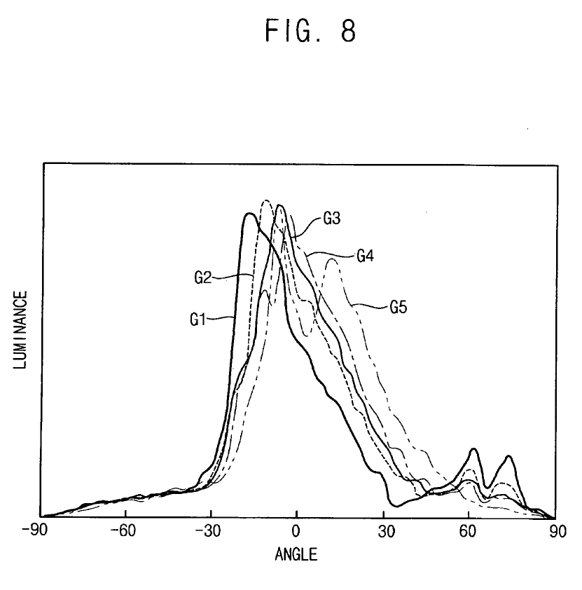

FIG. 8 is a graph showing a relationship between vertical light-emitting angles and luminance in accordance with a ratio of a base length of a first slanted surface and a base length of a second slanted surface. In FIG. 8, a graph line G1, a graph line G2, a graph line G3, a graph line G4 and a graph line G5 represent distributions of vertical light-emitting angles when an interior angle γ between the first slanted surface 352 and the second normal line NL2 of the light-emitting surface 230 is about 35°, about 38°, about 39°, about 40° and about 42°, respectively.

Referring to FIG. 8, the distribution of light-emitting angles is close to a vertical line, as the interior angle γ between the first slanted surface 352 and the second normal line NL2 of the light-emitting surface 230 is gradually increased from about 35° to about 40°. Moreover, a peak of the light-emitting angle is decentralized, when the first interior angle γ1 is more than 40°. The first interior angle γ1 is between the first slanted surface 352 and the second normal line NL2 of the light-emitting surface 230.

Therefore, when the first interior angle γ1 between the first slanted surface 352 and the second normal line NL2 of the light-emitting surface 230 is about 39°, a prism efficiency of a vertical direction is maximized.

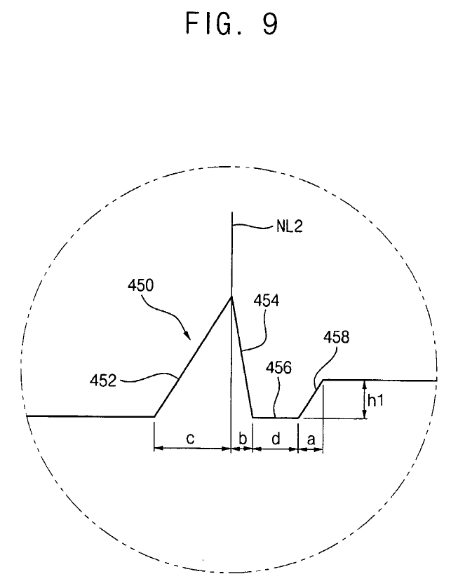

FIG. 9 is an enlarged cross-sectional view illustrating first prism patterns as shown in FIG. 5, according to another exemplary embodiment of the present invention.

Referring to FIGS. 2 and 9, the first prism patterns 450 include a first slanted surface 452, a second slanted surface 454, a flat surface 456, and a third slanted surface 458.

The first slanted surface 452 is extended from the light-reflecting surface 240 toward the light-emitting surface 230, and is inclined with respect to the light-reflecting surface 240. The second slanted surface 454 is extended from the first slanted surface 452 toward the light-reflecting surface 240, and is inclined with respect to the first slanted surface 452. The flat surface 456 is formed substantially parallel with the light-emitting surface 230 and between the second slanted surface 454 and the third slanted surface 458. The third slanted surface 458 is extended from the flat surface 456 substantially parallel with the first slanted surface 452 and is connected to the light-reflecting surface 240.

The flat surface 456 is formed between the second slanted surface 454 and the third slanted surface 458, so that the flat surface 456 enhances transferability in an injection molding process of the first prism patterns 450.

The first and second slanted surfaces 452 and 454 are substantially asymmetric with respect to the second normal line NL2 of the light-emitting surface 230. The base length ‘c’ of the first slanted surface 452 is greater than the base length ‘b’ of the second slanted surface 454. In particular, the ratio of the base length ‘c’ of the first slanted surface 452 to the base length ‘b’ of the second slanted surface 454 is about 4:1 to enhance luminance.

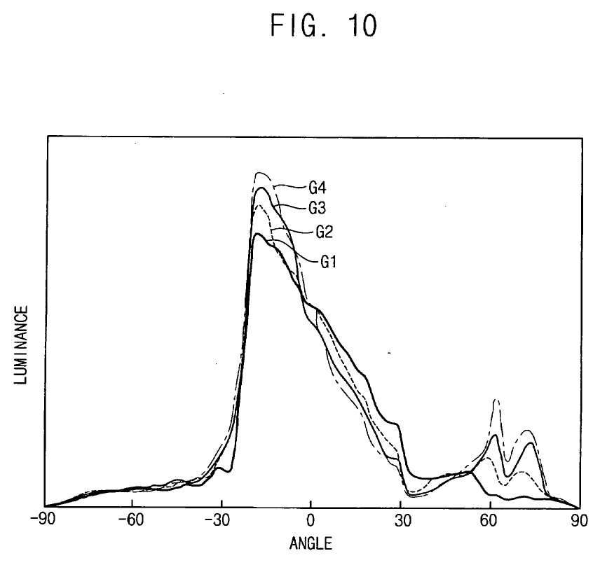

FIG. 10 is a graph showing a relationship between a vertical light-emitting angle and luminance according to a ratio of a base length of a first slanted surface to a base length of a second slanted surface. In FIG. 10, a graph line G1, a graph line G2, a graph line G3 and a graph line G4 represent the luminance distributions of the vertical light-emitting angles, when the ratio of the base length ‘c’ of the first slanted surface 452 to the base length ‘b’ of the second slanted surface 454 is about 1:1, about 4:3, about 2:1 and about 4:1, respectively. A sum of the base length ‘b’ of the second slanted surface 454 and the width ‘d’ of the flat surface is substantially equal to the base length ‘c’ of the first slanted surface 452.

Referring to FIG. 10, when the ratio of the base length ‘c’ of the first slanted surface 452 to the base length ‘b’ of the second slanted surface 454 is about 4:1, the luminance of the vertical light-emitting angle is the highest. Therefore, in FIG. 9, the ratio of the base length ‘c’ of the first slanted surface 452 to the base length ‘b’ of the second slanted surface 454 is about 4:1, so that the transferability of the first prism patterns 450 and the luminance of the LGP are enhanced. A width ‘d’ of the flat surface 456 is substantially equal to about ¾ of the base length ‘c’ of the first slanted surface 452.

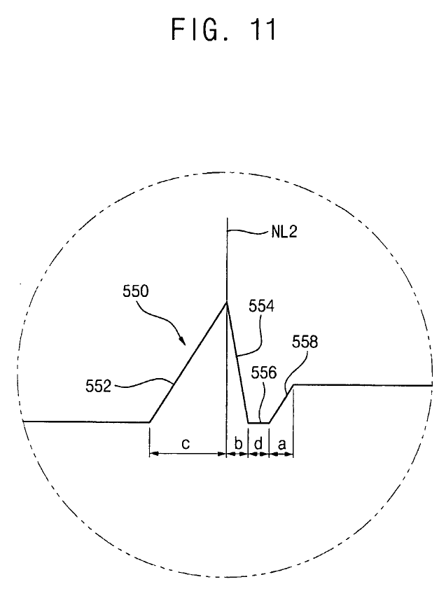

FIG. 11 is an enlarged cross-sectional view illustrating first prism patterns according to further exemplary embodiment as shown in FIG. 5.

Referring to FIGS. 2 and 11, the first prism patterns 550 include a first slanted surface 552, a second slanted surface 554, a flat surface 556, and a third slanted surface 558.

The first slanted surface 552 is extended from the light-reflecting surface 240 toward the light-emitting surface 230, and is inclined with respect to the light-reflecting surface 240. The second slanted surface 554 is extended from the first slanted surface 552 toward the light-reflecting surface 240, and is inclined with respect to the first slanted surface 552. The flat surface 556 is formed substantially parallel with the light-emitting surface 230 and between the second slanted surface 554 and the third slanted surface 558. The third slanted surface 558 is extended from the flat surface 556, which is substantially parallel with the first slanted surface 552, and is connected to the light-reflecting surface 240.

The first slanted surface 552 and the second slanted surface 554 are substantially asymmetric with respect to the second normal line NL2 of the light-emitting surface 230. The base length ‘c’ of the first slanted surface 552 is greater than the base length ‘b’ of the second slanted surface 554. In particular, the ratio of the base length ‘c’ of the first slanted surface 552 to the base length ‘b’ of the second slanted surface 554 is about 4:1 to enhance luminance.

In order to prevent a leakage of light through the third slanted surface 558, the flat surface 556 may have a small width. However, the flat surface 556 has enough width not to deteriorate the transferability of the first prism patterns 550. For example, a width d of the flat surface 556 may be about ¼ of the base length ‘c’ of the first slanted surface 552.

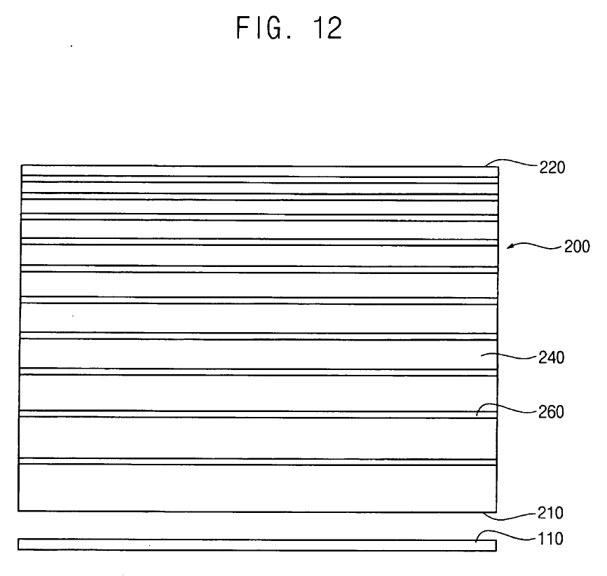

FIG. 12 is a plan view illustrating first prism patterns according to another exemplary embodiment as shown in FIG. 3.

Referring to FIG. 12, a plurality of first prism patterns 260 is formed in the light-reflecting surface 240. The first prism patterns 260 have a stripe shape that is formed substantially parallel with the light-incident surface 210. That is, the first prism patterns 260 are formed substantially parallel with a longitudinal direction of the lamp 110.

A distance between adjacent first prism patterns 260 is decreased, as a distance from the light-incident surface 210, which is disposed adjacent to the lamp 110, is increased. That is, the distance between the adjacent first prism patterns 260 is decreased, as a distance from the light-facing surface 220 is decreased. The distance between the adjacent first prism patterns 260 is a pitch between the first prism patterns 260.

Therefore, the pitch between the first prism patterns 260 is adjusted, so that uniformity of the light is enhanced.

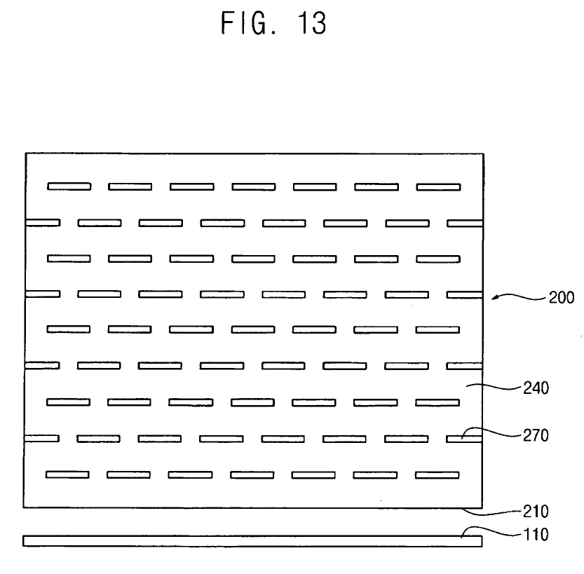

FIG. 13 is a plan view illustrating first prism patterns according to still another exemplary embodiment as shown in FIG. 3.

Referring to FIG. 13, a plurality of first prism patterns 270 are formed in the reflecting surface 240 of the LGP 200. The first prism patterns 270 have a stripe shape that is formed substantially parallel with the light-incident surface 210. That is, the first prism patterns 270 are formed substantially parallel with a longitudinal direction of the lamp 110.

Each of the first prism patterns 270 has an interrupted structure in order to adjust uniformity of the light. That is, each of the first prism patterns 270 has a dotted line shape. For an example, the interrupted portions of the first prism patterns 270 may be substantially the same. Alternatively, the interrupted portions of the first prism patterns 270 may be different from each other. Also, intervals between adjacent interrupted portions of the first prism patterns 270 may be substantially the same. Alternatively, the intervals between adjacent interrupted portions of the first prism patterns 270 may be decreased, as a distance from the light-incident surface 210 is increased.

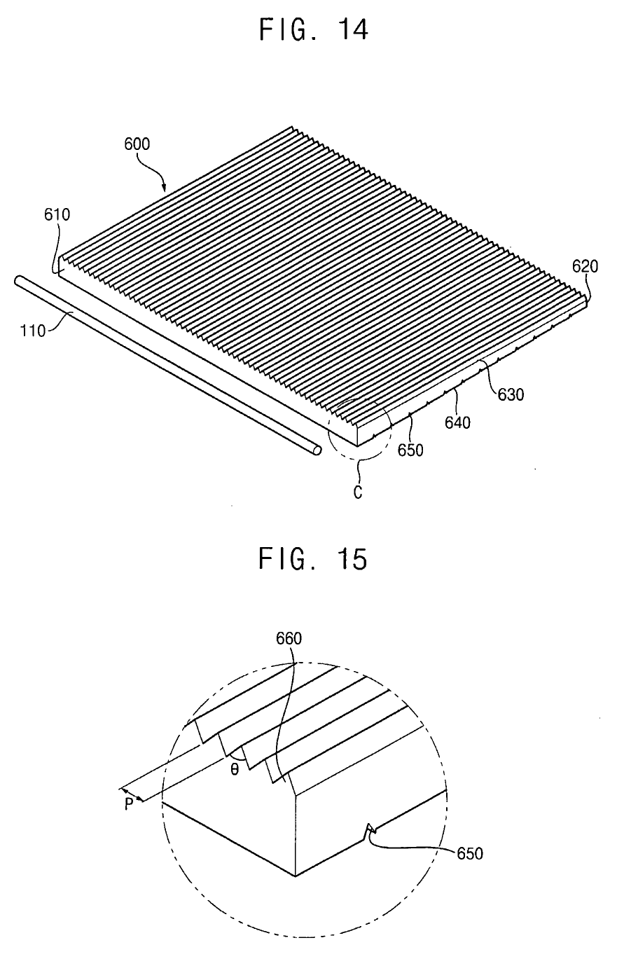

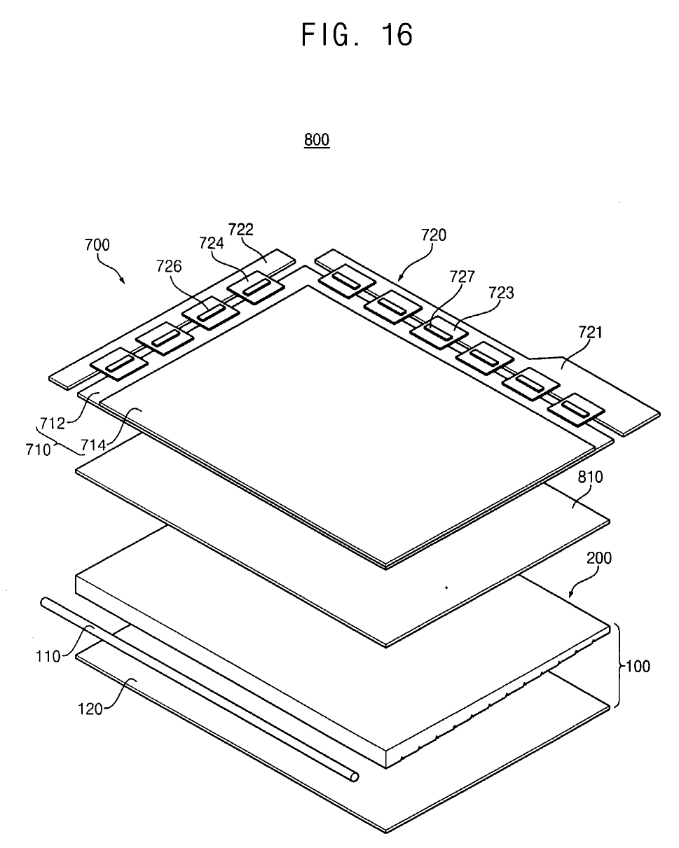

FIG. 14 is a perspective view illustrating an LGP according to another exemplary of the present invention. FIG. 15 is an enlarged perspective view illustrating portion ‘C’ in FIG. 14.

Referring to FIGS. 14 and 15, an LGP 600 according to another exemplary embodiment of the present invention includes a light-incident surface 610, a light-facing surface 620, a light-emitting surface 630 and a light-reflecting surface 640. The light-incident surface 610 receives the light that is generated from the lamp 110. The thickness of the LGP 600 at the light-facing surface 620 facing the light-incident surface 610 has a thinner thickness than the thickness of the LGP 600 at the light-incident surface 610. The light-emitting surface 630 extended substantially perpendicular to the upper side of the light-incident surface 610 is connected to the upper edge of the light-facing surface 620. The light-reflecting surface 640 extended from the base of the light-incident surface 610 is connected to the base of the light-facing surface 620. Therefore, the LGP 600 has a wedge shape. That is, a thickness of the LGP 600 is gradually decreased, as a distance from the light-incident surface 610 is increased.

First prism patterns 650 having a stripe shape are formed in the light-reflecting surface 640 of the LGP 600. The first prism patterns 650 are substantially parallel with the light-incident surface 610 of the LGP 600. Moreover, the light-reflecting surface 640 that is disposed between the first prism patterns 650 is formed substantially parallel with the light-emitting surface 630 to satisfy a total reflection condition of the guided the inner LGP 600.

Accordingly, the light that is incident into the inner LGP 600 through the light-incident surface 610 is totally reflected from the light reflecting surface 650 and the light-emitting surface 630. Then, a reflecting angle of the totally reflected light is changed by the first prism patterns 650, and the totally reflected light exits the LGP 600 through the light-emitting surface 630.

The first prism patterns 650 are the same as those of shown in FIGS. 4 to 13. Thus, any further explanations concerning the above elements will be omitted.

A plurality of second prism patterns 660 that are adjacent to each other is formed in the light-emitting surface 630 of the LGP 600. The second prism patterns 660 are formed in the front surface of the light-emitting surface 630. The second prism patterns 660 condense the light exiting the LGP 600 through the light-emitting surface 630 in a front direction of the LGP 600 to enhance front luminance.

The second prism patterns 660 are formed substantially perpendicular to a longitudinal direction of the lamp 110. That is, the second prism patterns 660 are substantially perpendicular to the light-incident surface 610. Therefore, the first prism patterns 650 and the second prism patterns 660 are formed substantially perpendicular to each other.

The second prism patterns 660 have, for example, a substantially triangular cross-section that is substantially perpendicular to the longitudinal direction. The interior angle θ of each of the second prism patterns 660 is about 90° to about 130°. For example, the interior angle θ may be about 110°. A pitch P between the second prism patterns 660 is about 50 μm to about 150 μm.

Alternatively, the upper portion of each of the second prism patterns 660 may have a round shape. That is, an end portion that is between two slanted surfaces of each of the second prism patterns 660 may have the round shape. Alternatively, the second prism patterns 660 may have a substantially half-elliptical shape or a substantially half-circular shape when viewing the cross-sectional view of the LGP 600, the plane of the cross-section being perpendicular to a longitudinal direction of the second prism patterns 660.

FIG. 16 is an exploded perspective view illustrating a liquid crystal display (LCD) device according to an exemplary embodiment of the present invention.

Referring to FIG. 16, an LCD device 800 according to an exemplary embodiment of the present invention includes a backlight assembly 100 generating the light and a display assembly 700 displaying an image using the light exiting the backlight assembly 100.

The backlight assembly 100 includes a lamp 110 generating the light, an LGP 200 guiding a path of the light that is generated from the lamp 110 and a reflective sheet 120 that is disposed below the LGP 200. The LGP 200 may be of various types such as shown in FIGS. 1 to 15. Therefore, detailed descriptions of the identical elements are omitted.

The display assembly 700 includes an LCD panel 710 for displaying an image using the light generated from the backlight assembly 100 and a driver circuit section 720 for driving the LCD panel 710.

The LCD panel 710 includes a first substrate 712, a second substrate 714 facing the first substrate 712 and a liquid crystal layer (not shown) that is disposed between the first substrate 712 and the second substrate 714.

The first substrate 712 is a thin-film transistor (TFT) substrate on which a plurality of TFTs is formed in a matrix configuration. For example, the first substrate 712 includes glass. Each of the TFTs has a source electrode electrically connected to the data line, a gate electrode electrically connected to a gate line and a drain electrode electrically connected to a pixel electrode (not shown) that includes a transparent and conductive material.

The second substrate 714 is a color filter substrate on which red (R), green (G) and blue (B) pixels (not shown) are formed as a thin-film shape. The second substrate 714 includes the glass. The second substrate 714 also includes a common electrode (not shown) formed thereon. The common electrode also includes the transparent conductive material.

When power is applied to the gate electrode of the TFT, the TFT is turned on so that an electric field is generated between the pixel electrode and the common electrode. The electric field varies an aligning angle of the liquid crystal molecules interposed between the first substrate 712 and the second substrate 714. Thus, light transmittance of the liquid crystal layer is changed in accordance with the variation of the aligning angle of the liquid crystal molecules to display a desired image.

The driver circuit section 720 includes a data printed circuit board (PCB) 721, a gate PCB 722, a data driver circuit film 723 and a gate driver circuit film 724. The data PCB 721 provides the LCD panel 710 with a data drive signal. The gate PCB 722 provides the LCD panel 710 with a gate drive signal. The data driver circuit film 723 electrically connects the data PCB 721 to the LCD panel 710. The gate driver circuit film 724 electrically connects the gate PCB 723 to the LCD panel 710.

The data driver circuit film 723 and the gate driver circuit film 724 include at least one of a data driver chip 725 and a gate driver chip 726, respectively. Each of the data and gate driver circuit films 723 and 724 includes a tape carrier package (TCP) or a chip-on-film (COF).

Alternatively, separated signal wirings may be formed on the LCD panel 710 and the gate driver circuit film 724 so that the gate PCB 722 may be omitted.

The LCD device 800 may further include optical sheets 810 that are disposed between the backlight assembly 100 and the LCD panel 710.

The optical sheets 810 enhance luminance characteristics of the light that exits the LGP 200. The optical sheets 810 may further include a diffusion sheet for diffusing the light exiting the LGP 200 to enhance luminance uniformity. Moreover, the optical sheets 810 may further include a prism sheet that condenses the light exiting the LGP 200 in a front direction to enhance front luminance uniformity. Moreover, the optical sheets 810 may further include a reflection-polarizing sheet that transmits a portion of the light that satisfies a predetermined condition and reflects the remaining portion of the light to enhance luminance uniformity. According the above, the LCD device 800 may include various optical sheets in accordance with luminance characteristics of the LCD device 800.

The LCD device 800 may further include a top chassis (not shown) so as to secure the LCD panel 710 to the backlight assembly 100. The top chassis is coupled to the receiving container (not shown) to secure an end of the LCD panel 710 to the backlight assembly 100.

According to the LGP including the backlight assembly having the LGP and the LCD device having the backlight assembly, symmetric or asymmetric prism patterns are formed in a portion of the light-reflecting surface of the wedge-type LGP, and the remaining portion of the light-reflecting surface of the wedge-type LGP is formed substantially parallel with the light-emitting surface. Therefore, a leakage of light that exits from the LGP through a side surface of the LGP is decreased, so that luminance is enhanced. Furthermore, uniformity of the luminance and transferability of a stamping method are enhanced.

Moreover, the prism patterns are formed in the light-emitting surface of the LGP, so that front luminance of the light is enhanced.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A light-guide plate comprising:
a light-incident surface receiving light;
a light-facing surface having a smaller size than that of the light-incident surface, the light-facing surface facing the light-incident surface;
a light-emitting surface being extended substantially perpendicular to an upper side of the light-incident surface, and being connected to an upper edge of the light-facing surface; and
a light-reflecting surface having a plurality of first prism patterns that are formed substantially parallel with the light-incident surface, and being extended from a base of the light-incident surface to be connected to a base of the light-facing surface.

2. The light-guide plate of claim 1, wherein a width of the light-facing surface is smaller than a width of the light-incident surface.

3. The light-guide plate of claim 1, wherein the first prism patterns have a stripe shape.

4. The light-guide plate of claim 3, wherein the first prism patterns comprise:
a first slanted surface being extended from the light-reflecting surface toward the light-emitting surface, the first slanted surface being inclined with respect to the light-reflecting surface;
a second slanted surface being extended from the first slanted surface toward the light-reflecting surface, the second slanted surface being inclined with respect to the first slanted surface; and
a third slanted surface being extended from the second slanted surface, the third slanted surface being connected to the light-reflecting surface.

5. The light-guide plate of claim 4, wherein the third slanted surface and the first slanted surface are substantially parallel with each other.

6. The light-guide plate of claim 4, wherein the first and the second slanted surfaces are substantially symmetric with respect to a normal line of the light-emitting surface.

7. The light-guide plate of claim 6, wherein a height of the third slanted surface is about (d1−d2)/m, and wherein d1, d2 and m represent a width of the light-incident surface, a width of the light-facing surface and a number of steps of the light-reflecting surface, respectively.

8. The light-guide plate of claim 7, wherein a height of the first slanted surface is about h1×[1+tan(α)tan(β/2)]/[1−tan(α)tan(β/2)], and wherein h1, α, β, n1 and n2 represent a height of the third slanted surface, a sin⁻¹(n1/n2), an interior angle, a refractive index of a medium that is formed between the lamp and the light-incident surface, and a refractive index of the light-guide plate, respectively.

9. The light-guide plate of claim 8, wherein a lower base length of the third slanted surface is about h1×tan(β/2), and a lower base length of the second surface is about h2×tan(β/2), and wherein h1 and h2 indicate the height of the third slanted surface and the height of the first slanted surface.

10. The light-guide plate of claim 9, wherein the interior angle β between the first slanted surface and the second slanted surface is about 60° to about 90°.

11. The light-guide plate of claim 4, wherein the first and the second slanted surfaces are substantially asymmetric with respect to a normal line of the light-emitting surface.

12. The light-guide plate of claim 11, wherein a lower base length of the first slanted surface is greater than a lower base length of the second surface.

13. The light-guide plate of claim 12, wherein the ratio of the lower base length of the first slanted surface to the lower base length of the second slanted surface is about 4:3.

14. The light-guide plate of claim 12, wherein the ratio of the lower base length of the first slanted surface to the lower base length of the second slanted surface is about 4:1.

15. The light-guide plate of claim 14, further comprising a flat surface being formed substantially parallel with the light-emitting surface between the second slanted surface and the third slanted surface.

16. The light-guide plate of claim 15, wherein a width of the flat surface is about ¾ of the lower base length of the first slanted surface.

17. The light-guide plate of claim 15, wherein a width of the flat surface is about ¼ of the lower base length of the first slanted surface.

18. The light-guide plate of claim 12, wherein an interior angle between the first slanted surface and a normal line of the light-emitting surface is about 34° to about 44°.

19. The light-guide plate of claim 18, wherein an interior angle between the first slanted surface and the normal line of the light-emitting surface is about 39°.

20. The light-guide plate of claim 3, wherein each of the first prism patterns has an interrupted structure.

21. The light-guide plate of claim 3, wherein the first prism patterns are spaced apart from each other by a constant distance.

22. The light-guide plate of claim 3, wherein a distance between the first prism patterns is decreased, as a distance from the light-incident surface is increased.

23. The light-guide plate of claim 1, further comprising a plurality of second prism patterns that are adjacent to each other on the light-emitting surface.

24. The light-guide plate of claim 23, wherein the second prism patterns are substantially perpendicular to the light-incident surface.

25. The light-guide plate of claim 24, wherein an interior angle of the second prism patterns is about 90° to about 130°.

26. A backlight assembly comprising:
a lamp generating light;
a light guide plate guiding a path of the light generated from the lamp; and
a reflective sheet being disposed below the light-guide plate,
wherein the light-guide plate comprises:
a light-incident surface receiving the light;
a light-facing surface having a smaller size than that of the light-incident surface, the light-facing surface facing the light-incident surface;
a light-emitting surface being extended substantially perpendicular to an upper side of the light-incident surface to be connected to an upper edge of the light-facing surface; and
a light-reflecting surface having a plurality of first prism patterns that are formed substantially parallel with the light-incident surface, and being extended from a base of the light-incident surface to be connected to a base of the light-facing surface.

27. The backlight assembly of claim 26, wherein the first prism patterns have a stripe shape.

28. The backlight assembly of claim 27, wherein the first prism patterns comprise:
a first slanted surface being extended from the light-reflecting surface toward the light-emitting surface, the first slanted surface being inclined with respect to the light-reflecting surface;
a second slanted surface being connected to the first slanted surface, the first and second slanted surfaces having a substantially symmetric structure with respect to a normal line of the light-emitting surface; and
a third slanted surface being extended from the second slanted surface, the third slanted surface being connected to the light-reflecting surface.

29. The backlight assembly of claim 27, wherein the first prism patterns comprise:
a first slanted surface being extended from the light-reflecting surface toward the light-emitting surface, the first slanted surface being inclined with respect to the light-reflecting surface;
a second slanted surface being extended from the first slanted surface, the first and second slanted surfaces being substantially asymmetric with respect to a normal line of the light-emitting surface; and
a third slanted surface being extended from the second slanted surface substantially parallel with the first slanted surface, the third slanted surface being connected to the light-reflecting surface.

30. The backlight assembly of claim 29, wherein a lower base length of the first slanted surface is greater than a lower base length of the second surface.

31. The backlight assembly of claim 30, further comprising a flat surface being formed substantially parallel with the light-emitting surface between the second slanted surface and the third slanted surface.

32. The backlight assembly of claim 26, further comprising a plurality of second prism patterns that are formed substantially perpendicular to the light-incident surface in the light-emitting surface.

33. A liquid crystal display device comprising:
a backlight assembly having a lamp generating light and a light-guide plate guiding a path of the light generated from the lamp; and
a display assembly having a liquid crystal layer, the display assembly displaying an image using the light having passed through the liquid crystal layer,
wherein the light-guide plate comprises,
a light-incident surface receiving light;
a light-facing surface having a smaller size than that of the light-incident surface, the light-facing surface facing the light-incident surface;
a light-emitting surface being extended substantially perpendicular to an upper side of the light-incident surface to be connected to an upper edge of the light-facing surface; and
a light-reflecting surface having a plurality of first prism patterns that are formed substantially parallel with the light-incident surface, and being extended from the base of a light-incident surface to be connected to a base of the light-facing surface.

34. The liquid crystal display device of claim 33, wherein the first prism patterns have a stripe shape.

35. The liquid crystal display device of claim 34, further comprising a plurality of second prism patterns that are formed in the light-emitting surface substantially perpendicular to the light-incident surface.
